(19) United States
(12) Patent Application Publication
(10) Pub. No.: US 2013/0180256 A1
(43) Pub. Date: Jul. 18, 2013

(54) TURBINE FUEL NOZZLE ASSEMBLY AND METHOD FOR OPERATING A TURBINE

(71) Applicant: Lucas John Stoia, Taylors, SC (US)

(72) Inventor: Lucas John Stoia, Taylors, SC (US)

(73) Assignee: GENERAL ELECTRIC COMPANY, Schenectady, NY (US)

(21) Appl. No.: 13/351,815

(22) Filed: Jan. 17, 2012

(51) Int. Cl. F02C 7/232; F02C 3/00

(52) U.S. Cl. 60/772; 60/740

(57) ABSTRACT

According to one aspect of the invention, a fuel nozzle assembly for a turbine includes an outer conduit of a fuel nozzle and a cap assembly to receive at least a portion of the fuel nozzle. The assembly also includes a spring disposed about the outer conduit and within an annular recess of the cap assembly, wherein the spring provides frictional damping to resist movement of the fuel nozzle.

### BACKGROUND OF THE INVENTION

The subject matter disclosed herein relates to gas turbines. More particularly, the subject matter relates to an assembly of gas turbine stator components.

In a gas turbine engine, a combustor converts chemical energy of a fuel or an air-fuel mixture into thermal energy. The thermal energy is conveyed by a fluid, often air from a compressor, to a turbine where the thermal energy is converted to mechanical energy. Components in the turbine engine may be subject to stress due to vibration within the turbine. Specifically, fuel nozzles may be subject to vibration caused by various sources, such as combustion dynamics, fluid flow, blade passing and rotor vibration. In some cases, the vibration may occur at a natural frequency for the component, thus causing an increase in the amplitude or intensity of the vibration, further stressing the component which may lead to high cycle fatigue crack initiation.

### BRIEF DESCRIPTION OF THE INVENTION

According to one aspect of the invention, a fuel nozzle assembly for a turbine includes an outer conduit of a fuel nozzle and a cap assembly to receive at least a portion of the fuel nozzle. The assembly also includes a spring disposed about the outer conduit and within an annular recess of the cap assembly, wherein the spring provides frictional damping to resist movement of the fuel nozzle.

According to another aspect of the invention, a method for operating a turbine includes the steps of directing air into a fuel nozzle and directing fuel into the fuel nozzle, wherein the nozzle includes an outer conduit. The method also includes frictionally damping movement of the nozzle using a wave spring disposed about the outer conduit and within an annular recess of a cap assembly.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an embodiment of a gas turbine system;

FIG. 2 is a sectional side view of an exemplary turbine assembly;

FIG. 3 is a detailed sectional side view of a portion of the exemplary turbine assembly shown in FIG. 2; and

FIG. 4 is a perspective view of an exemplary wave spring.

The detailed description explains embodiments of the invention, together with advantages and features, by way of example with reference to the drawings.

### DETAILED DESCRIPTION OF THE INVENTION

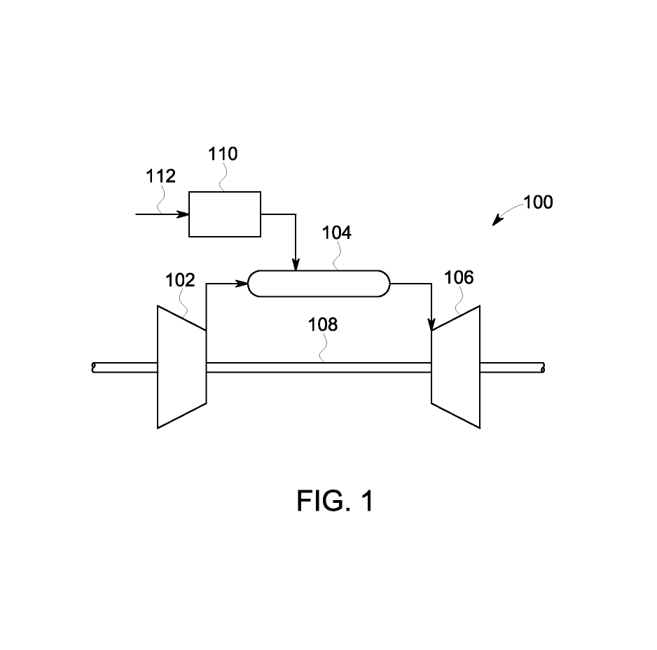

FIG. 1 is a schematic diagram of an embodiment of a gas turbine system 100. The system 100 includes a compressor 102, a combustor 104, a turbine 106, a shaft 108 and a fuel nozzle 110. In an embodiment, the system 100 may include a plurality of compressors 102, combustors 104, turbines 106, shafts 108 and fuel nozzles 110. The compressor 102 and turbine 106 are coupled by the shaft 108. The shaft 108 may be a single shaft or a plurality of shaft segments coupled together to form shaft 108.

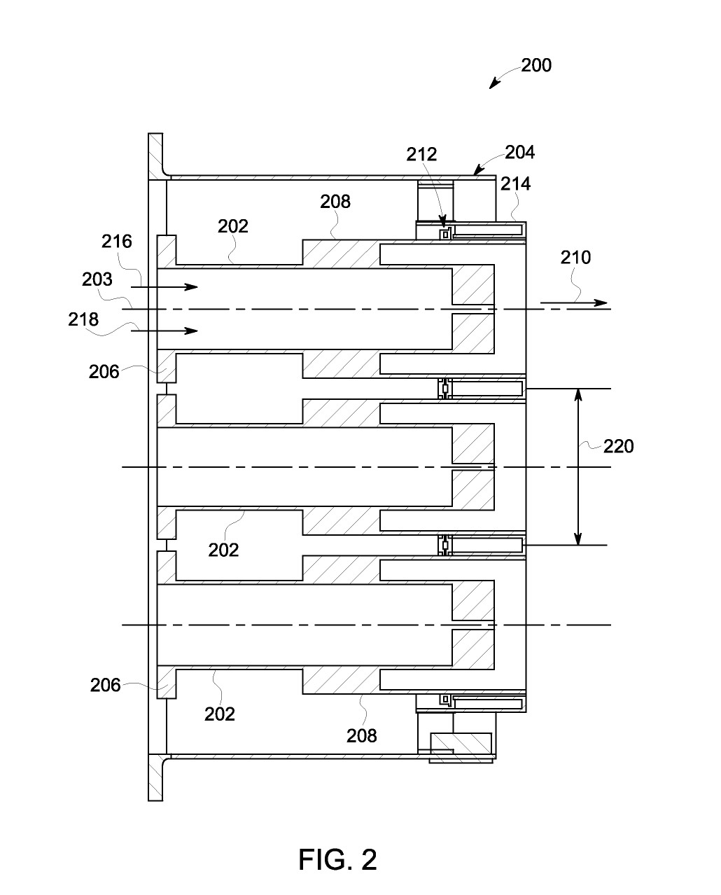

In an aspect, the combustor 104 uses liquid and/or gas fuel, such as natural gas or a hydrogen rich synthetic gas, to run the engine. For example, fuel nozzles 110 are in fluid communication with an air supply and a fuel supply 112. The fuel nozzles 110 create an air-fuel mixture and discharge the air-fuel mixture into the combustor 104, thereby causing a combustion that heats a pressurized gas. The combustor 104 directs the hot pressurized exhaust gas through a transition piece into a turbine nozzle (or “stage one nozzle”) and then a turbine bucket, causing turbine 106 rotation. The rotation of turbine 106 causes the shaft 108 to rotate, thereby compressing the air as it flows into the compressor 102. In an embodiment, a first end of each fuel nozzle 110 is coupled to an end cover of the combustor 104 and a second end of the fuel nozzle is positioned in a cap assembly. As discussed in detail below, an assembly disposed about a portion of each of the nozzles 110 reduces vibration and associated stresses experienced by the nozzles 110. Vibration in the turbine system 100 may be induced by various sources, such as combustion dynamics, fluid flow and movement of rotational components. Exemplary embodiments of the fuel nozzles 110 and parts proximate the nozzles are discussed in detail below with reference to FIGS. 2-4.

As used herein, “downstream” and “upstream” are terms that indicate a direction relative to the flow of working fluid through the turbine. As such, the term “downstream” refers to a direction that generally corresponds to the direction of the flow of working fluid, and the term “upstream” generally refers to the direction that is opposite of the direction of flow of working fluid. The term “radial” refers to movement or position perpendicular to an axis or center line. It may be useful to describe parts that are at differing radial positions with regard to an axis. In this case, if a first component resides closer to the axis than a second component, it may be stated herein that the first component is “radially inward” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. Although the following discussion primarily focuses on gas turbines, the concepts discussed are not limited to gas turbines and may apply to other rotating machinery and/or steam turbines.

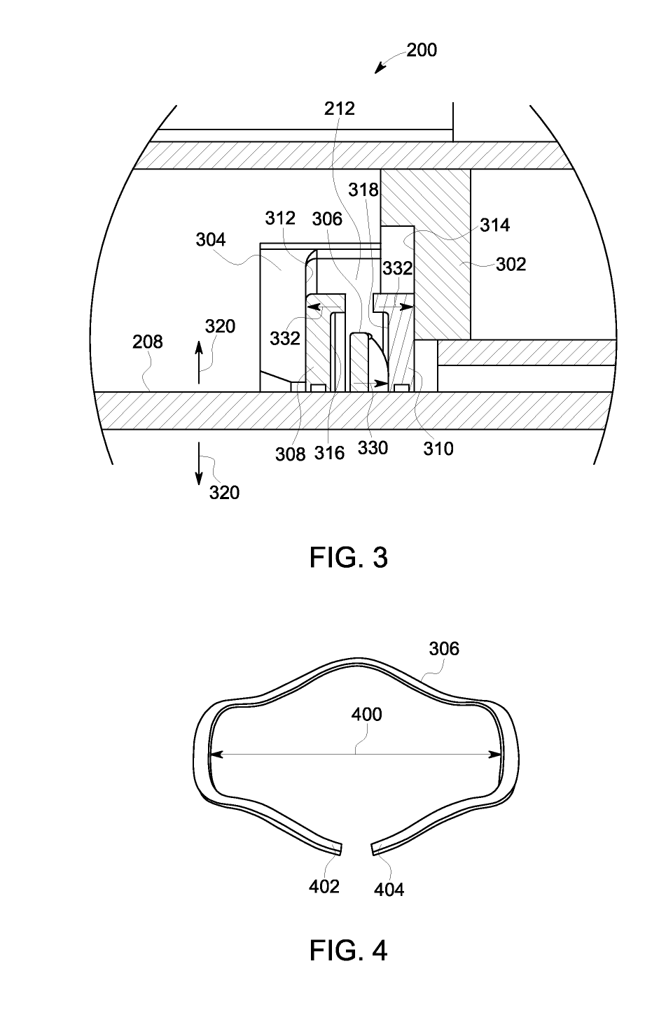

FIG. 2 is a sectional side view of an exemplary turbine assembly 200 that includes a plurality of fuel nozzles 202 disposed in a cap assembly 204. The fuel nozzles 202 are each disposed about an axis 203. In embodiments, the turbine assembly 200 may include any suitable number of nozzles 202, ranging from one nozzle to 5, 6, 7, 8 or 9 nozzles. For ease of explanation, the embodiment discussed includes nozzles 202 that are substantially identical, although in some cases the nozzles and surrounding components may differ. The exemplary fuel nozzles 202 are configured to couple to an end cover or plate via flanges 206. In an embodiment, the fuel nozzles 202 include outer conduits 208, also referred to as burner tubes, wherein at least a portion of the outer conduits 208 are received within a cap 214 of the cap assembly 204. The nozzles 202 and outer conduits 208 may be any suitable geometry, including, but not limited to, circular, hexagonal and octagonal cross-sections. In an embodiment, the outer conduits 208 have a substantially circular cross-section with an outer diameter 220. An annular recess 212 is formed by one or more components of the cap assembly 204, wherein the annular recess 212 receives a spring configured to provide frictional damping to resist movement of the nozzle 202, as shown below in FIG. 3. As depicted in FIG. 2, each fuel nozzle 202 receives a fuel flow 216 and air flow 218, wherein the air and fuel are mixed to form an air-fuel flow 210 directed from the fuel nozzle 202 into a combustor. In embodiments, the fuel flow 216 may be gas fuel, liquid fuel or a combination thereof

FIG. 3 is a detailed sectional side view of a portion of the exemplary turbine assembly 200. A backing plate 302 and retainer plate 304 of the cap assembly 204 form the annular recess 212. A spring, such as a wave spring 306, is positioned in the annular recess 212 between washers 308 and 310. In one embodiment, the wave spring 306 is positioned in the annular recess without the washers 308 and 310. As depicted, the wave spring 306 is axially compressed when positioned between the washers 308 and 310 in the annular recess 212. The wave spring 306 is disposed about the outer conduit 208 of the fuel nozzle 202. The axial compression of the wave spring 306 causes the washer 308 in contact with a surface 312 of the annular recess 212. Similarly, the compressed wave spring 306 causes contact between the surface 314 and washer 310. The compression of wave spring 306 causes contact and normal forces between the washers and recess surfaces, as depicted by force arrows 332. In addition, the spring compression also causes contact and normal forces between the wave spring 306 and washer surfaces 316 and 318, as depicted by force arrow 330. Thus, in order for the fuel nozzle 202 to move radially, as shown by arrows 320, the movement forces must overcome the normal forces and frictional contact between the wave spring 306, washer 308, washer 310, backing plate 302 and retainer plate 304. This resistance to radial movement provides frictional damping for the fuel nozzle 202. Accordingly, fuel nozzle 202 vibration is reduced or restricted by the arrangement of the wave spring 306, washer 308, washer 310, backing plate 302 and retainer plate 304 within the turbine assembly 200. In embodiments, the coupling of the flange 206 to an end cover may cause a cantilever condition for the fuel nozzle 202, wherein the depicted arrangement of the wave spring 306 restricts radial movement and vibration of the nozzle proximate the nozzle end opposite the flange 206. As part of the cantilever condition, the only contact or support for the fuel nozzle 202 distal from the flange 206 is provided by the wave spring 306. In addition, the arrangement provides support for the fuel nozzle 202 while also reducing fluid flow or leaks along the outer conduit 208. Specifically, the wave spring 306 and washers 308, 310 reduce axial flow of fluid, such as air, along the outside of the conduit. The ability for the wave spring and washers 308, 310 assembly to have radial clearance in backing plate 302 and retainer plate 304 enables adjustment for positional tolerance of the fuel nozzle 202.

FIG. 4 is a perspective view of an exemplary wave spring 306. The wave spring 306 has an inner diameter 400 and is an open or C-shaped spring. In an embodiment, when the spring is placed on the outer conduit 208, ends 402 and 404 of the spring are drawn apart because the inner diameter 400 is less than the outer diameter 220 of the conduit. Thus, the expanded wave spring 306 is fitted to and in contact with the outer surface of the outer conduit 208. The dimensions, geometry and material of the wave spring 306 may be altered based on the application requirements. For example, the number of waves in the wave spring 306 may be configured to provide the desired normal force when the spring is compressed within the annular recess 212, as discussed above. In an embodiment, the wave spring 306 exerts normal force against the washers 308 and 310 at locations where the spring and washer surfaces 316, 318 contact one another. In an example where the number of waves in the spring is low (e.g. 2-5 waves), the spring and washers may contact one another 2, 3, 4 or 5 times on each side of the spring. In an example where the number of waves is high, the number of contact points between the spring and washers is also high. The amplitude or size of the wave may also be altered to provide the desired forces when compressed. Further, the thickness and/or material of the wave spring 306 may be configured to provide the desired forces when compressed. In addition, more than one wave springs 306 may be provided, wherein stacking springs wave to wave (aligned or in phase) increases stiffness while stacking wave peak to wave trough (180 degrees out of phase) reduces stiffness. In an example, the wave spring 306 is formed from a suitable material able to withstand the temperature and stress experienced by the fuel nozzle 202, such as a steel alloy or a nickel alloy. In addition, the spring disposed in the recess 212 may be any suitable biasing member that provides the desired properties (e.g., compression and frictional contact or coupling), such as helical springs, wave springs or any other suitable elastic mechanism capable of storing mechanical energy.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel nozzle assembly for a turbine, the assembly comprising:
an outer conduit of a fuel nozzle;
a cap assembly to receive at least a portion of the fuel nozzle; and
a spring disposed about the outer conduit and within an annular recess of the cap assembly, wherein the spring provides frictional damping to resist movement of the fuel nozzle.

2. The assembly of claim 1, wherein the spring comprises a wave spring in contact with an outer surface of the outer conduit.

3. The assembly of claim 1, wherein the cap assembly comprises washers disposed on each side of the spring within the annular recess, wherein the spring is axially compressed between the washers.

4. The assembly of claim 1, wherein the spring is axially compressed when placed in the annular recess and exerts a force against at least one surface in the annular recess.

5. The assembly of claim 4, wherein the force exerted against the at least one surface in the annular recess provides the frictional damping for the fuel nozzle.

6. The assembly of claim 1, wherein the spring has an inner diameter that is less than an outer diameter of the outer conduit.

7. The assembly of claim 1, wherein the spring provides frictional damping to resist radial movement of the fuel nozzle.

8. The assembly of claim 1, wherein the cap assembly comprises a backing plate and retainer plate that form the annular recess.

9. A method for operating a turbine, the method comprising:
directing air into a fuel nozzle;
directing fuel into the fuel nozzle, wherein the nozzle comprises an outer conduit; and
frictionally damping movement of the nozzle using a wave spring disposed about the outer conduit and within an annular recess of a cap assembly.

10. The method of claim 9, wherein frictionally damping comprises axially compressing the wave spring in the annular recess formed by a backing plate and retainer plate and wherein the wave spring is in contact with an outer surface of the outer conduit.

11. The method of claim 9, wherein frictionally damping comprises axially compressing the wave spring between washers in the annular recess.

12. The method of claim 9, wherein frictionally damping comprises axially compressing the wave spring to exert a force against at least one surface in the annular recess.

13. The method of claim 12, wherein the force exerted against the at least one surface in the annular recess provides the frictional damping for the fuel nozzle to resist radial movement of the fuel nozzle.

14. The method of claim 9, wherein the wave spring has an inner diameter that is less than an outer diameter of the outer conduit.

15. A fuel nozzle assembly for a turbine, the assembly comprising:
washers configured to be placed about an outer conduit of a fuel nozzle; and
a wave spring configured to be axially compressed between the washers and disposed about the outer conduit, wherein the washers are configured to provide frictional damping with a force exerted against a surface of a recess that receives the wave spring and washers.

16. The assembly of claim 15, wherein the recess is formed in a backing plate and retainer plate.

17. The assembly of claim 15, wherein the wave spring is in contact with an outer surface of the outer conduit and the force exerted against the surface resists radial movement of the fuel nozzle.

18. The assembly of claim 15, wherein the force is exerted by the wave spring on the washers and is also exerted by the washers on the surface of the recess, wherein the force is caused by compression of the wave spring.

19. The assembly of claim 15, wherein the wave spring has an inner diameter that is less than an outer diameter of the outer conduit.

20. The assembly of claim 15, wherein the wave spring comprises a nickel alloy.
